(19) United States
(12) Patent Application Publication
(10) Pub. No.: US 2020/0242150 A1
(43) Pub. Date: Jul. 30, 2020

(54) Method for creating an efficient, logically complete, ontological level in the extended relational database concept

(71) Applicant: Elnaserledinellah Mahmoud Elsayed Abdelwahab, Cairo (EG)

(72) Inventor: Elnaserledinellah Mahmoud Elsayed Abdelwahab, Cairo (EG)

(21) Appl. No.: 16/596,147

(22) Filed: Oct. 8, 2019

(30) Foreign Application Priority Data
Oct. 9, 2018 (DE) 10 2018 008 923.2

(51) Int. Cl. G06F 16/36; G06F 16/28; G10L 15/26; G06N 5/00

(52) U.S. Cl. CPC G06F 16/367; G06N 5/003; G10L 15/265; G06F 16/284

(57) ABSTRACT

In relational database concepts, query procedures suffer either from logically incomplete query results or lack of query time efficiency. The present invention provides efficient methods that optimize relational database systems in their query procedures so that the response procedure experiences an increase in efficiency in terms of speed and memory requirements without sacrificing logical conditions.

In order to increase the efficiency of the query methods, a logically complete and at the same time efficient ontological level is introduced, which makes it possible to derive and/or evaluate application-specific constraints both, deductively and inductively.

It is the object of this invention to provide methods by which one can create a logically complete, efficient, ontological conceptual system in the catalog level of a relational database system that allows deduction as well as complete induction in its most general form insofar as that logical and natural language explanations of all system responses can be achieved. The inventive solution to this problem is specified in the claims 1-13.

### TECHNICAL FIELD

The invention relates to a method for creating an ontological term system in the meta level of the relational database model, which is at the same time efficient and logically complete. In furtherance of the writing the entire system is called: Rational system (RS). The components of the ontological level of this system (listed in FIG. 1) are as follows:
1) Ontology Description Component (ODC), consisting of a graph- or logic-based editor of axioms (ontology structure) and facts.
2) Decision Tree Component (DTC), which has the goal to provide selected constraints in CNF form as explicit Binary Decision Diagrams using SAT-solver methods. This component contains a CNF-based Constraints Definition Component (CDC) and a Solution Counting Procedure (SCP).
3) Inductive Derivative Component (IDC), whose task is to generate combinatorics for selected parts of the overall system, for which no explicit constraints are known. In consequence, a complete induction procedure assists in inferring such constraints.
4) Deductive Derivative Component (DDC) that applies syllogisms to selected parts of the overall system using a Language Recognition Component (LRC). A Translation Component (TRC) ensures that records from the database are rewritten into categorical statements.
5) Rational Response Component (RRC), which can explain each response to a request made to the overall system by means of stored constraints (of DTC or IDC).

In contrast to known methods in deductive and relational databases, the RS not only allows linear processing times for entries and the improvement of database query procedures without endangering the logical consistency (cf. DE102015013593A1), but also allows a balanced application of known, efficient, logical procedures for the overall system: While DTC uses efficient methods of a priori completion for selected, difficult Boolean functions, DDC achieves fast response times regardless of the usual SQL machinery. According to the invention, this is achieved by simple, natural language-supported, syllogistic-based methods.

In addition, RRC offers the possibility of an intelligent system reaction, which justifies every answer using rules of logic (hence the property: rational). The constraints obtained by IDC do not require explicit verification and/or test procedures, since they originate from a mathematically stringent, complete induction. Using such constraints, the IDC also allows a compact representation of the combinatorics of selected parts of the overall system. The RS thus fulfills all the necessary criteria of a practically implementable logical system in its most general form, which can be used for terminological and logical control in most database applications.

### PRIOR ART

Methods are known for generating ontology models from requirement documents and software as well as carrying out consistency checks between requirement documents and software code using ontology models. Terms are identified from the large number of requirement documents that are stored in a database. A processor assigns a term a word-tag. The word-tag indicates a grammatical use of each term in the requirement documents. The processor classifies each term based on word-tags. To form an ontology, the classification identifies whether each term is a part, symptom, action, event, or failure mode. The processor constructs an ontology-based consistency machine. A consistency check is carried out by applying the ontology-based consistency engine between ontologies extracted from two context documents. Inconsistent terms between the context documents are identified. At least one of the context documents with inconsistent terms is corrected (cf. DE102015121509A1). The disadvantage here is that the consistency and completeness of the ontology constructed in this way is disregarded.

Methods are known in which ambiguity is handled, which occurs when natural language information is combined with the knowledge represented by ontologies. Ambiguity is due to the fact that the same natural language identifier can denote several elements of the ontology. These procedures present a basic methodology of how the appropriate ontology element can be determined despite ambiguity. The approach is based on the human approach and the use of the context for monosemination. This represents the relationship between the entities mentioned in the text. These methods simulate the context of the text envelope based on the relationships within the ontology graph and disambiguate it by analyzing it. It is disadvantageous that the logical derivation (whether deduction or induction) is not affected (cf. Kleb, J.; Ontologie-basierte Monosemierung—Bestimmung von Referenzen im Semantic Web; KIT Scientific Publishing; 2015; DOI 10.5445/KSP/1000031500).

Methods are known for supporting the search for proven and existing solutions in the context of the development of technical products. Access to these solutions is made possible by considering the functions of technical systems from a usage perspective. The searcher is provided with a suitable solution space with relevant solutions using semantic networks. This can limit and expand the room according to various criteria. The disadvantage here is that in the case of more complex search tasks, the logical machinery is disregarded (cf. Gaag, A.; Entwicklung einer Ontologie zur funktionsorientierten Lösungssuche in der Produktentwicklung; Verlag Dr. Hut; 2010, ISBN 978-3-86853-731-4).

Methods are known for integrating semantic data processing in a device, in particular in a field device of automation technology. A generic description language scheme is used to define a semantic depot as a starting point. This description language scheme is enriched with contents of an ontology for the semantic representation of functioning of the device. Classes and/or subclasses of the ontology are taken from the ontology together with at least one property assigned to the classes and/or subclasses, converted into a corresponding schema declaration and finally this schema declaration is inserted into the description language schema. Then, one or more grammars are generated from the description language scheme, preferably grammars according to the standardized data format Efficient XML Interchange, which are integrated in the device. A particular advantage of the method lies in the significantly more compact semantic data processing and data transmission. Hereby it is disadvantageous to disregard the logical features of the semantic data processing achieved and the associated ontology role (cf. WO2016110356A1).

Methods are known which give a user the opportunity to create databases and similar applications from imported ontologies. These databases can be configured specifically and come with error detection rules. The search in these databases is based on “meanings” instead of specific words. Ontology management guarantees consistent data integration, maintenance and flexibility, and also enables easy communication between multiple databases. Only the relevant ontology parts are considered for a specific application (sub-model). To ensure efficiency, the sub-model is then translated into an object-oriented, API-supporting Java application. The disadvantage is that no consistency or completeness criteria of the imported ontologies can be adopted and/or enforced (cf. U.S. Pat. No. 6,640,231).

Methods are known in which an ontology-related query is used to generate synonyms of words in database applications that could find relevant data records in addition to those used in the database queries. The disadvantage is that this search becomes even more complex with logically complex database queries (cf. U.S. Pat. No. 8,135,730).

Methods are known in which pairs of similar terms that exist in an OWL document are stored in a relational database and then used in database queries that establish semantic relationships between the two terms. It is disadvantageous that these methods cannot influence logically complex database queries (cf. U.S. Pat. No. 7,328,209).

General methods for handling constraints programming in the context of continuous or discrete variables for modeling mathematical or algorithmic problems are known (cf. DE4411514A1 and U.S. Pat. No. 5,216,593). The disadvantage is that these methods are not suitable for general database concepts.

Methods are known in which the most important referential integrity constraints are set in advance when creating an SQL execution plan (cf. U.S. Pat. No. 5,386,557). The disadvantage is that user-specific constraints are no longer possible. To ensure this, U.S. Pat. No. 5,488,722 discloses that a custom database restriction method depends on the likelihood of a consistency break. After that, the constraints that are probably not met are applied first. It is disadvantageous that this method is not generally applicable, since the establishment of a suitable hierarchy for the application priority of a restriction application requires the result of a database query, so that there are always non-ranked constraints when evaluating database queries.

In order to increase the efficiency of the query procedures, methods are known in which various predicates within a logical program are assigned a certain order rank (cf. EP0545090A2). Here, the assignment of the logical predicates affects the level of the term system, but not the logical deduction procedure (SLD resolution).

Methods are known for checking conditions for large amounts of data in a database (cf. EP0726537A1; Hirao, T.: Extension of the semantic processing model for relational databases, in: IBM Systems Journal, Volume 29, No. 4, 1990; p. 539 to 550 and Lippert, K.: Heterogene Kooperation, in: ix Multiuser Multitasking Magazin 7/1994, p. 140-147). The procedures specified therein are procedural and therefore have no logical-declarative form.

Methods according to DE19725965C2 are known which deal with general constraints of the extended relational database concept at the deductive catalog level. It is disadvantageous that the expansion of the logical theory can be very large, that is, exponential in the length of the logical formulas used.

Methods according to DE102015013593A1 are known in which the general restriction handling in extended relational database concepts is carried out in such a way that logical completeness methods at the catalog level can be used efficiently (i.e., not exponentially) in order to enable a maximum execution speed of logical queries. It is disadvantageous that term-related query processing is not dealt with explicitly. The possibility of using complete induction processes for the overall system is ignored. In addition, according to DE102015013593A1 no methods are specified with which the solutions of a set of CNF formulas can be counted efficiently. In addition, no syllogistic-based deduction applies. The answers of the system described in DE102015013593A1 lack a logical, natural explanatory component.

No methods are known with which a logically complete, efficient, ontological term system can be created at the catalog level of a relational database system, which enables the deduction and the complete induction in its most general form to the extent that logical (rational) explanations in a natural language of all system reactions can be achieved.

The Logical Completion

The rule sets occurring in a logical system must meet correctness and completeness criteria. In the context of this invention, it is said to be “complete” if axioms and rules of deduction explicitly derive everything that can be deduced.

In (Bancilhon, F.; Maier, D.; Sagiv, Y.; Ullman, J D: Magic sets and other strange ways to implement logic programs, Proc. ACM SIGMOD-SIGACT Symp. Of principles of database systems, Cambridge (Mass.), 1986), (Bayer, R.: Query Evaluation and Recursion in Deductive Database Systems, Manuscript, March 1985) or (Lozinskii, E L: Evaluation queries in deductive databases by generating, Proc. Int. Joint Conference on AI, 1: 173-177, 1985) there are alternative methods of completion.

These either concern the inference process itself, i.e., the way in which the rules are applied or the facts of the database relevant to the request. One method that deals with the inference process itself is the so-called semi-naive completion (cf. Bancilhon, F.; Ramakrishnan, R.: An Amateur's Introduction to Recursive Query Processing Strategies, Proc. Of the ACM SIGMOD-SIGACT Conference, Washington D.C., May 1986).

This tries to avoid the unnecessary repetition of generation steps by only using the incrementally generated facts, i.e. the facts that emerged in the last iteration are taken into account (cf. Chang, C L; Gallaire, H.; Minker, J.; Nicholas, M.: On the evaluation of queries containing derived relations in relational databases, Advances in database theory, Vol. I, 1981, or Marq-Puchen; Gallausiaux, M.; Jomien: Interfacing Prolog and Relational Database Management Systems, New applications of databases, Gardavin and Gelaube eds. Academic Press, London, 1984).

The assumption ΔRᵢ is that ΔRᵢ=(Rᵢ∪F(Rᵢ₋₁∪ΔRᵢ₋₁))−Rᵢ for every relation Rᵢ (here the incremental change of Rᵢ and F(Rᵢ) is the functional expression that is deduced from the body of a rule). In general, one cannot simply calculate ΔRᵢ as a function of ΔRᵢ₋₁. In the case of linear recursive rules, however, this is possible because F(Rᵢ₋₁∪ΔRᵢ₋₁)=F(Rᵢ₋₁)∪F(ΔRᵢ₋₁)=Rᵢ∪F(ΔRᵢ₋₁).

As long as one can assume that the rules are linear-recursive, semi-naive completion is an efficient method. However, if the flexibility is expanded and non-linear recursions are allowed, this method is no longer efficient (the early realizations of semi-naive approaches are not valid for this type of recursion). Furthermore, the exponential effort is only reduced by reducing the number of facts of the one pattern relevant for the last deduction step. In a link A₁\hat{ }A₂\hat{ } . . . \hat{ }S\hat{ } . . . Aₙ where S corresponds to this pattern, the facts that unify S are taken into account, but links between the Aᵢ must always be established again. It has been found that creating the AND operations is the most complex step in the completion procedure. The so-called APEX procedure (cf. Lozinskii, E L: Evaluation queries in deductive databases by generating, Proc. Int. Joint Conference on AI, 1: 173-177, 1985) is a procedure of a different kind. First, those for a definite query clause W (Target) relevant facts of a database are generated, only then to start the completion process. The relevant facts are calculated using so-called control system graphs. These contain all the logical links between rules of the database.

They are started with coupling a query generation process which, in the case of important AND operations, generates further queries W1?, W2? . . . . etc. The generation takes place through sideway information passing (SIP) between the query or queries and the facts of the respective link(s). Another method of this class is QSQ (cf. Vieille, L.; Recursive axioms in deductive databases: The Query-Subquery approach, Proc. First Int. Conf. On expert database systems, Kerschlag ed., Charlston, 1986). As in APEX, database rules are used for the generation of new queries. However, as in PROLOG, the relevant facts are searched for linearly and in depth using a backward chaining procedure. In the case of recursive predicates, the queries are generated using SIP using the facts already found.

The main difference between APEX and QSQ on the one hand and semi-naive completion on the other hand is that the solution of semi-naive completion deals with the general and principal problem of inferring basic facts, whereas the other two methods only try to optimize the usual inference mechanisms by taking the relevant facts into account.

Magic Sets (cf. Beeri, C.; Ramakrishnan; On the power of magic, Proc. Sixth ACM SIGMOD-SIGACT Symp. On principles of database systems, San Diego, Calif., March 1987) is a modification of QSQ, which the adds variable bindings in the form of new “magic” rules to a program or links them to the right side of a clause as constraints. Starting with the target clause, a lot of new predicates are generated. SIP succeeds in forwarding these adornments. The result is a new, modified version of the first program, which in some cases is more efficient. For example, the program:
anc(X,Y)←par(X,Y).
anc(X,Y)←anc(X,Z)\hat{ }par(Z,Y).
   and the query q(X)←anc(a,X).
   the new “magic” program:
magic(a).
q(X)←anc(a,X).
anc(X,Y)←par(X, Y).
anc(X,Y)←magic(X)\hat{ }anc(X, Z)\hat{ }par(Z, Y).
magic(Z)←magic(X)\hat{ }anc(X,Z).

The new magic predicate represents a restriction of the permissible substitutions. It systematically connects the program constants with each other.

Practical Considerations the Nature of a Logical Variable

The basic problem with constraint handling is to reduce the effort involved in applying a set of constraints. Solution approaches amount to generating instances of these rules before an adequate application of the constraints is activated. The fact that many solution approaches achieve a high degree of efficiency through variable instantiation calls for a fundamental discussion about the importance of a variable in the closed world of a deductive database and an RD model. The usual meaning of a variable in mathematical logic (and thus in logical programming) boils down to considering it as an entity detached from the domain of the application. The link between a variable instantiation and the domain is therefore unclear, because there are no explicit or implicit rules in the interpretation to describe these instantiation procedures. This access is therefore left to the implementation of a logical machine, which can lead to considerable problems.

DE19725965C2 solves this problem by introducing the Herbal Abstraction Structure. Here, variables are viewed as abstractions of terms and term relationships at the catalog level. This approach makes it possible to describe alternative completion methods that make it possible to move from a standard Herbrand interpretation to a “more complete” one using any degree of abstraction. If one reverses the “abstraction process”, i.e. if one starts with un-instantiated clauses, the Herbal Abstraction Structure enables procedures that can split clauses of a logical program into a number of “more instanced” clauses. This in turn leads to the increase in efficiency described there (linearization). However, the method formalized in

DE19725965C2 (Alg. 2) does not specify a method for how the instantiation of the rules could be optimized. This could be achieved in a variety of ways in a Herbal Abstraction Structure. In addition, the main weakness of using the Herbal Abstraction Structure is that in the worst case it represents an exponential search space.

The method presented in DE102015013593A1, however, leads to complete evaluation methods depending on a new representation of variables as parts of the classic truth table, also called pattern strings or pattern trees. In contrast to the state-of-the-art resolution methods, these lead to small search spaces in which linear processing times of inputs can be realized. Here, the term “inputs” always means instantiations of logical formulas. A procedure is used to generate the extension that resolves model trees instead of clauses.

In this context, two types of resolution procedures for formulas/clauses (also known as Solvers) are known: complete and incomplete. A Solver is called complete if it can both determine that a formula can be fulfilled and that it cannot be fulfilled. Not all formulas that can occur in a Solver formula set fall into the same category. In practice, a distinction is made between three categories:
Random: formulas that are generated randomly according to a scheme called “fixed clause length model” (one only specifies the number of variables and clauses and how long a clause should be, the rest is generated randomly)
Crafted: formulas derived from difficult combinatorial problems such as graph coloring
Application: formulas that are derived from applications in reality (e.g., circuit verification)

Not all known solver paradigms cope equally well with all formula categories. A distinction is made between four types of solvers, which are dealt with in DE102015013593A1. All four solver methods can be characterized by the following features and are therefore significantly different from DE102015013593A1 and from the method according to the invention presented below:
1. They are an example of the application of Tarski's semantic concept of truth regarding formulas in mathematical logic. This term basically prescribes that variables exist separately from their meanings or values. These meanings are replaced in the formulas so that they are fulfilled. Thus, variables (and their associated literals) are only viewed as containers that do not allow structural information about the data stored in them to be derived or used.
2. A by-product of this view is that algorithmic methods are forced to test different variable evaluations before they find a valid one. The term variable evaluation is therefore an integral part of this procedure.
3. Information from the specific mathematical-logical formula, which relates to the concatenation of used variables (literals) and their mutual interactions, is not used or is used only inadequately (usually in the form of heuristics) in order to find the/a valid evaluation.
4. All methods avoid the construction of the entire combinatorial space, since this construction is exponential with regard to the number of variables. Since the methods use variable evaluations iteratively, only a part of the space is constructed in each iteration, the formula is then evaluated and the next iteration is started, etc.
5. Because the methods usually do not use general heuristics, their performance strongly depends on the type of formula (Tab. 1). “Good”, “bad” and “neutral” are hereby rough indicators of the expected performance of a method in relation to a given type of formula. “SAT/UNSAT” stands for “satisfiable” or “unsatisfiable”:

TABLE 1

| Category | CDCL | Look-ahead | Message-passing | SLS |
|---|---|---|---|---|
| Random SAT | bad | neutral | good | good |
| Random UNSAT | bad | good | bad | bad |
| Crafted SAT | good | neutral | bad | neutral |
| Crafted UNSAT | neutral | neutral | bad | bad |
| Application SAT | good | bad | bad | bad |
| Application UNSAT | neutral | bad | bad | bad |

Ultimately, a solver method is known that corresponds to the classic truth table method. It differs from the methods described in DE102015013593A1 as follows:
1. Part of the method is the construction of the entire exponential space of all combinations of the variable values. After this space has been constructed, one can efficiently determine whether a particular evaluation of variables for the respective formula results in “true” or not.
2. In contrast to all other methods, finding a solution does not include trying variable-values in the original formula, but the simple search in the generated space, i.e., in the truth table. This makes it possible to find the truth value of the instantiated formula without making use of the classic, logical operators (AND, OR, NOT), since the full extension of these operators, applied to the logical values “true” and “false”, is material.
3. The number of variable evaluations that one has to go through until a productive value is found is exponential in the worst case. This potential exponentiality is the main disadvantage.
4. Because no assumptions are made about the formulas, the performance of the process is independent of the type of formula.

### OBJECTIVE OF THE INVENTION

The objective of this invention, while maintaining the strictest logical conditions, is to optimize relational database systems in their most general concept, by means of a logically complete, ontological meta-level, which allows deductive as well as inductive reasoning in their logical query methods so that the response procedure experiences linear efficiency in terms of speed and storage requirements.

### NATURE OF THE INVENTION

The invention is based on the objective of creating a method of the type mentioned at the outset which optimizes relational database systems in their query methods in such a way, that the response procedure experiences an increase in efficiency with regard to the speed and the memory requirement without having to give up logical conditions. This is achieved by introducing a logically complete and at the same time efficient ontological level, which allows application-specific constraints to be derived and/or evaluated deductively and inductively. This objective is achieved with process steps as specified in claims 1-13.

### Example of Accomplishment

### Extension of the RDS Through the Concept of a Logically Complete, Efficient, Ontological Term System in the Catalog

The central method of this invention is based on the idea of either explicitly defining all the data and rules necessary for the terminological, logical and application-specific control or making them available in advance in the catalog by means of complete induction. As a result, not only is the constraint treatment dealt with more efficiently, but also some calculation requirements that are not possible in common relational systems. Consistency properties of databases are only logical in nature and therefore meta problems. The basic assumption of this invention is that the ontological term system of a database application remains sufficiently constant. We call this condition below: closed ontology. This should not be confused with the logical “closed world assumption”, which in the context of logical systems expresses the fact that facts that are not explicitly stored in the database are considered “wrong”. The following example explains this procedure:

Be given a used printing database. This contains the tables “Machine”, “Company” and “Numbering Unit” as shown in (FIG. 1). The following describes possible conditions that are not easy to handle in conventional relational systems and that claim parts of the entire system shown here:
1. Among other things, the table “Machine” has the fields “Machine type” and “Printing group”. These are of particular interest because their combination models important constraints known in the printing industry. E.g., a Polar machine cannot belong to the group of 5-color printing machines, because the type “Polar” represents cutting machines. Similarly, a Heidelberg-Tiegel never has more than 2 inking units, so that the combination (type=“Tiegel”, group=“3 colors”) corresponds to no logic. We call such factual constraints of the term system: Type-1-Constraints
2. Machines cannot have more than 5 numbering units. This condition can only be implemented by programming (usually: stored procedures), since neither entity nor table diagrams are able to express conditions via cardinalities of the relationships, except by “many” and “one”. We call general conditions that have to do with cardinalities of the relations in the relational data model: Type-2-Constraints
3. In the printing industry, machines are occasionally transported to and from different physical locations. Companies that intend to keep transport costs to a minimum therefore always need, among other things, calculations of the best transport routes. We call these types of calculation-intensive tasks that can be represented using general Boolean functions that can be expressed in CNF: Type-3-Constraints
4. Sometimes it is necessary to know the factory standard configuration of a machine type in order to carry out a comparison with the used machine of the same type (e.g., whether the standard configuration is with or without a numbering unit in the factory). This request is related to both manufacturer specifications in the term system and the current used machine database. We call such constraints: Type-4-Constraints
5. All inquiries that are exclusively related to the database are usually handled with common SQL components. This includes, for example: “Which companies currently supply Tiegel machines?”. We call this type of constraint: Type-5-Constraints
6. Inquiries such as: “Which parts are supplied with a Tiegel machine?” And “Which parts are supplied by a particular company with a Tiegel machine?” Are Type-1 and Type-4 constraints examples that are used for their execution require the calculation of the transitive envelope of the respective relationships. Stored procedures are used in common relational database contexts because SQL does not allow loops by default. We name queries that cannot be solved using SQL alone: Type-6-Constraints
7. Derivation of formulas of the form: “All machines from company X are always completely overhauled and delivered with care” or “There are only a few spare parts that are compatible with a numbering system” are only possible if the entire data set and/or facts of the term system is taken into account. We call these: Type-7-Constraints

The following table (Tab. 2) shows the order of constraint types for different system components.

The descriptions and definitions following in Table 2 explain the functionalities according to the invention of the various components of the overall system with reference to FIG. 1.

TABLE 2

| Con- | System- | |
|---|---|---|
| straint | component | Comment |
| Type-1, | CDC, DTC, | Constraints related to term systems and relations |
| Type-2 | RRC, | are given in CDC, defined in CNF form, and |
| | record- | evaluated by means of DTC. They are used in |
| | validation | RRC for the generation of intelligent answers. |
| | | Furthermore, they affect the customary record |
| | | validation component. |
| Type-3 | CDC, DTC, | General Boolean functions are defined in |
| | SCP, RRC | CDC in CNF form. Solver method 1 in DTC |
| | | converts to BDD (Binary Decision Diagram), |
| | | whose information are made available to |
| | | RRC. SCP provides for the number of different |
| | | solution alternatives |
| Type-4, | CDC, DTC, | Constraints that have to do with both the |
| Type-5, | OBC, TRC, | database and the term system or those that are |
| Type-6 | DDC, LRC | only database-related can be handled in two |
| | | ways: either one first defines them in CNF |
| | | form in CDC, then they are evaluated using |
| | | DTC, or: selected records are in TRC initially |
| | | translated into categorical statements, then |
| | | used for deduction by means of DDC. As |
| | | DDC allows recursion, this also covers Type |
| | | 6 constraints. LRC provides that they are |
| | | represented in the natural language. |
| Type 7 | IDC, DDC, | Database and term system provide a finite |
| | LRC | number of field/fact combinations for which |
| | | the creation of complete combinatorial tables |
| | | is possible. Rules can then be derived by |
| | | means of complete induction (Method 9) |
| | | and correspond to the “all” or “existence”- |
| | | quantified formulas in Type 7. |

Definition 1: Given the set B of all terms in an application to which all-quantified, existential, negated and indefinite terms, i.e., variables, include: A logical conclusion is called syllogism if two premises (prerequisites), called upper- and lower sentences, lead to a conclusion. In a categorical syllogism (also called assertory syllogism), premises and conclusions are categorical judgments, i.e., statements in which a term from B, the subject, another term from B, the predicate, is assigned or denied in a certain way.

Definition 2: Let kSyl be the set of all known, valid categorical syllogisms and hSyl be the set of all known, valid hypothetical syllogisms of the form: From ( [symbol] ) and ( [symbol] ) one derives ( [symbol] ), where P, Q, R are categorical sentences and ‘ [symbol] ’ are syntactic derivation relations, then categorical sentence s is called the logical consequence of the categorical sentence set S (S→_{Syl} s) ifs results from Syl=kSyl∪hSyl using Syllogisms. We call the list of deduction steps that lead to a sentence s from a sentence set S using rules from Syl: Derivation of s from S (SΔₛ). If s contains no variables, it is called a fact. If SΔₛ is empty, it is called an axiom.

Definition 3: An ontology Ont=(B,R) is a tuple in which B is a set of all terms of an application and R is a set of all intended n-ary relationships between these terms. Alternatively, instead of R one can use the set of all categorical sentences S of the form: <Termᵢ>is<Propertyⱼ>of<Relationₖ> This is possible because:

∀r ∈ R, ∀bᵢ ∈ R: r(b₁,b₂,...bₙ) iff {
s₁=b₁_is_property₁_of_r,
s₂=b₂_is_property₂_of_ r,
....
Sᵢ=bᵢ_is_propertyⱼ_of_r.
}

The sentence sᵢ is called the descriptive sentence of the relationship r. Descriptive sentences can only be facts.

Definition 4: An ontology Ont=(B,S), S set of all description sets of the relationships between terms in B, can also be represented in the form of a directed graph with marked nodes: A directed graph or digraph with node markings G=(V,E,M) consists of:
A set V of nodes
A set of ordered pairs of nodes E⊆V×V of edges
A set M of marks on the edges

An ontology is called consistent if:
the equivalent directed graph G is acyclic
∀s₁,s₂∈S, s₁,s₂: Axiom: s₁≠¬s₂

Definition 5: A consistent ontology Ont=(B,S) is called complete if ∀s∈S, s follows logically from the axioms: SΔₛ. Ont is called closed if the set B has a fixed, constant cardinality. This simple concept of completeness is possible because the set Syl contains known logically complete subsets of derivation methods (cf. Moss, L S; Completeness Theorems for Syllogistic Fragments, in F. Hamm and S. Kepser (eds.) Logics for Linguistic Structures, Mouton de Gruyter, 2008, 143-173). The correctness of the set Syl is also known and is assumed here.

Definition 6: In the consistent ontology Ont=(B,S), constraints of the form:

(s₁& s₂ & s₃ . . . sₙ)>c,
where s₁,s₂, . . . sₙ,c∈S, the characters &: “and” and “>”: mean material implication, called categorical constraints. The premises: s₁,s₂, . . . sₙ are called categorical conjunctions. We call terms that are used in categorical conjunctions: decision terms. The term c is called: Conclusion.

Definition 7: A grammar is a 4-Tuple

G=(V_{N}, V_{T},P,S) where:
1. V_{N} is a finite, non-empty set, the set of non-terminal characters,
2. V_{T} is a finite, non-empty set, the set of terminal characters,
3. P is a finite subset of V*×V*, the set of productions or rules,
4. S∈V_{N} is the starting signal.

A Diacritics-Grammar (DiaG) is a grammar that allows terminal characters with diacritics from V_{T}. We call terminal and non-terminal signs and productions that allow diacritics: dia-terminal/non-terminal and DiaProduction.

Example of a grammar for sentences in the English language:
G=(V_{N},V_{T},P,S)
V_{N}={noun phrase, verb phrase, proper name, article, noun, verb}
V_{T}={Susanne,cat,horse,hay,book,the,hunts,eats,reads}
P={(sentence->nominal phrase verb phrase.),
(Noun phrase->proper name|article noun),
(Verb phrase->verb|verb noun phrase),
(Proper name->Susanne),
(Noun->cat|horse|hay|book),
(Article->the),
(Verb->hunts|eats|reads)}.
S=sentence

Example of a DiaG for the Arabic language:
G=(VN, VT, P, S)
V_{N}={noun phrase, verb phrase, proper name, noun, verb}
V_{T}={ [symbol] , [symbol] , [symbol] , [symbol] , [symbol] , [symbol] , [symbol] [symbol] , [symbol]
   [all words/word patterns in the Arabic dictionary]}
P={(sentence->nominal phrase verb phrase.),
   (Nominal phrase->statement “ [symbol] noun),
   (Verb phrase->verb|“ [symbol] noun verb),
   (Noun->certain|indefinite),
   (Determined->AlNounPattern|Genitive|Iproper name),
   (Proper name->{ . . . all known names . . . })
   (Genitive->“ [symbol] certain “ [symbol] indefinite|“ [symbol] indefinite “ [symbol] indefinite)
   (AlNounPattern->NounPattern “ [symbol] ”)
   (Noun pattern->{ . . . all noun patterns in the dictionary . . . })
   (Verb->{ . . . all verb patterns in the lexicon . . . })
   (Statement->Determined|Undefined|Verb phrase)}.
S=sentence

1. CDC The Constraints Definition Component consists of a simple text editor, in which one defines CNF formula sets.

2. ODC Like CDC, the Ontology Description Component can consist of a text editor in which categorical description sentences and/or constraints can be defined, or a graph editor in which terms and their relationships can be expressed in the form of nodes and edges.

3. DTC The Decision Tree Component is the central unit in which one evaluates Boolean functions f expressed in CNF. The result is a decision tree (BDD) that is equivalent to the truth table off. Method 1 is the central method in this component and uses the pattern property of the logical variables described in DE102015013593A1 in the following way:

Method 1:

Input: CNF clause set S

Output: BDD

Steps:
1. Use Method 2 to rename the formula set S to an equivalent S′. This renaming takes into account sample lengths in the form described in Method 2.
2. Select literal X of the first clause CE S′ for the instantiation. X is the literal with the least index.
3. Apply the evaluations: {X=TRUE} then {X=False} to S′. This application results in left and right clause sets S₁, S₂.
4. If either S₁ or S₂ becomes TRUE or False, output TRUE/False nodes for the respective clause set.
5. If neither S₁ nor S₂ are found in a container LCS (list of already processed clause sets): Initiate a recursive call first with S₁, then with S₂. This results in a left (leftRes) and a right (rightRes) result. If not: Initiate a recursive call with only the clause set that was not found in LCS. Return the found BDD for the other.
6. The end result of the resolution of clause set S′ is a node with left child leftRes and right child rightRes.

Method 2:

Input: CNF clause set S

Output: CNF clause set S′ that meets the following conditions:
1. ∀l₁,l₂,l₃, . . . ,lₙ∈C of S′: lᵢ appears before lⱼin C, if i<j, i.e., indexes of the literals are sorted in ascending order within the S′ clauses.
2. S′ is sorted according to in ascending order, taking negation into account.
3. Formally: ∀i,j: If i<j, then Lᵢ∈C appears before Lⱼ∈D in S′, where Lᵢ is head literal (i.e., first literal) of C and Lⱼ head literal of D.
4. ∀x∈LIT(S′), LIT(S′) is the set of all literals in S′, ∀C∈S′::

If x∉LEFT (x, C) then ∀y∈LEFT(x,C): x>y. LEFT (x,C) is a function that returns all variable indices that exist before the variable x from clause C in the string representation of the formula set S′. (In other words, this condition stipulates that all new indices that appear in a clause for the first time must be larger than all those already used in S′).
5. S′ is a set, i.e., clauses only appear once in it.

Steps:
1. current set=Method3(S)
2. while [current set is not sorted as in condition b)]
   a) sort CurrentSet according to condition b)
   b) CurrentSet=Method3(CurrentSet)
3. S′=CurrentSet
4. Return S′

Method 3:

Input: CNF clause set S

Output: CNF clause set S′

Steps:
1. Number clauses in S in increasing order (start with 0).
2. Set up a table with rows of literals in S and columns with clauses.
3. For each clause Cᵢ:
   a) Sort literals in Cᵢ in increasing order so that those that have not yet been renamed and appear in a larger number of clauses appear first.
   b) For all literals in Cᵢ: Create a new row and write down TRUE or False values, depending on whether the literal appears in the column clause or not.
4. Rename all literal indexes in increasing order in the table. Start with 0.
5. Construct all clauses of S using the new names/indices. The resulting set of clauses is S′.
6. Return S′.

Example: If S={{0.5} {0.2} {1.3} {1.4} {2,3}}, the table in point 2 looks like this:

| | C₀ | C₁ | C₂ | C₃ | C₄ |
|---|---|---|---|---|---|
| 0 | TRUE | TRUE | False | False | False |
| 5 | TRUE | False | False | False | False |
| 2 | False | TRUE | False | False | TRUE |
| 1 | False | False | TRUE | TRUE | False |
| 3 | False | False | TRUE | False | TRUE |
| 4 | False | False | False | TRUE | False |

According to point 4:

| | C₀ | C₁ | C₂ | C₃ | C₄ |
|---|---|---|---|---|---|
| 0 | TRUE | TRUE | False | False | False |
| 1 | TRUE | False | False | False | False |
| 2 | False | TRUE | False | False | TRUE |
| 3 | False | False | TRUE | TRUE | False |
| 4 | False | False | TRUE | False | TRUE |
| 5 | False | False | False | TRUE | False |

The new set of clauses: S′={{0.1} {0.2} {3.4} {3.5} {2.4}}. This set does not meet all of the conditions in Method 2 and requires a new ordering and renaming loop. In this new loop the clause set is: S″={{0.1} {0.2} {2.4} {3.4} {3.5}} for S′″={{0.1} {0.2} {2, 3} {3,4} {4,5}} reformed. FIG. 2 shows an example execution of Method 1 on the CNF clause set: S={{0,1} {0,2} {1,3} {2,3} {3,4}}. The above Method 1 sets up the BDD for S, but cannot convey any information about the number of possible solutions. The following method fills this gap.

Method 4:

Input: BDD for CNF clause set S

Output: number of solutions

Steps: 1. numberedBDD=number nodes and edges in the BDD starting with 0 (Method 5)
2. Set numberSolutions for nodes n₀=0, numberSolutions for all edges of the first BDD level=1
3. For all levels i in numberedBDD
   a) For all edges eᵢ, j is the index of the edge in plane i:
      i. Set numberSolutions for eᵢⱼ=numberSolutions of the parent node
   b) For all nodes nᵢₖ, k is the index of the node in level i:
      i. If nᵢₖ TRUE (flower) is:
         numberSolutions from nᵢₖ=(Σeₓ*2^{i-Le})*2^{N-i},
         x is the index of an edge that leads to nᵢₖ, eₓ numberSolutions of such an edge, Lₑ edge plane of x (given with: Lₑ=Lₛᵣ+1,
         Sᵣ parent node of e), N number of variables in S
      ii. else: numberSolutions from nᵢₖ=Σeₓ*2^{-Le}
4. Return numberSolutions=ΣTnd, Tnd is TRUE node (flower)

Method 5:

Input: BDD for CNF clause set S

Output: BDD with numbered nodes, edges and levels

Steps:
1. Run the BDD in a recursive, depth-first manner. Number nodes and edges and create a linear, topological order. A topological order is basically an inequality that can be created linearly in the following way: For every two nodes n₁, n₂, children of n: set the inequality n<n₁<n₂ and add it, recursively in a depth-first Way until the final inequality. The inequality is supplemented by recursively placing children of node n, before children of node
2. For all u∈V (V node set of the BDD):
   dist(u)=∞
   dist(s)=0, s is root
3. For all u∈V, in the linearized order:
   dist(u)=Dist(u)
   Lᵤ=|dist(u)|

Dist:

Input: u∈V, BDD=(V,E), V node set, E edge set

Output: Integer representing the distance between u and the root

Note: l(u,vᵢ,) is the length of the edge from u to vᵢ (always: ‘−1’).

Steps:
for all edges v₁,v₂, . . . vₙ∈V such that: (u,vᵢ)∈E:

Dist (u) =
min {
[Dist (v₁) + l(u, v₁)], ....
[Dist (vₙ) + l(u, vₙ)]
}

FIG. 3 shows an execution of Method 5 on the BDD created for the clause set S={{0,1} {0,2} {0,4}} by means of Method 1. The following example sequence of operations shows the application of Method 4 to S:
a) Level-0: n₀=0
b) Level-1: e₀=1, eₛ=1, nₛ=eₛ*2^{l-Le5}=1*2¹⁻¹=1
c) Level-2: e₆=n₅=1, e₉=n₅=1, n₆=e₆*2^{l-Le6}=1*2²⁻²=1
d) Level-3: e₇=n₆=1, e₈=n₆=1, n₁=e₀*2^{l-Le7}=1*2³⁻¹+1*2³⁻³=5
e) Level-4: e₁=n₁=5, e₂=n₁=5, n₂=(e₁*2^{l-Le1})*2^{N-l}=(5*2⁴⁻⁴)*2⁵⁻⁴=10, n₃=e₂*2⁴⁻⁴=5
f) Level-5: e₃=n₃=5, e₄=n₃=5, , n₄=(e₃*2^{l-Le3})*2^{N-l}=(5*2⁵⁻⁵)*2⁵⁻⁵=5

NumberSolutions=n₄+n₂=15

4. DDC The central method in this component applies syllogisms of the set Syl until no new sentences can be derived.

Method 6:

Input: Categorical sentence set S

Output: Categorical sentence set S′Steps:
1. NewSentence=TRUE, S′=S
2. While (NewSentence=TRUE)
   For all syllogisms sy of the set Syl:
   a) Apply sy to S.
   b) If a new sentence s has arisen:
   Set NewSentence=TRUE, S′=S′∪s
   else NewSentence=False
3. Return S′

DDC contains a Translation Component (TRC), whose task is to convert selected data records into categorical statements. This is done using the following Method:

Method 7:

Input: Set D of selected data records

Output: Categorical sentence set S Steps:

```
1. For all data records r(b₁,b₂,...bₙ) ∈ D:
    i. Apply Definition 3:
    ∀r∈ R, ∀bᵢ∈ R: iff{
        s₁=b₁_is_property₁_of_r,
        s₂=b₂_is_property₂_of_r,
        ....
        sᵢ=bᵢ_is_propertyⱼ_of_r.
        }
    ii. Set ∀i: S=S∪ sᵢ
2. Return S.
```

5. LRC The Language Recognition Component has the task of converting sentences in natural language into categorical sentences. The opposite direction is trivial. To ensure this according to the invention, only noun sentences are taken into account. Different languages have different procedures in this regard, but all are based on being able to distinguish verbs, nouns and their connections at the word level. In Latin languages, this distinction is achieved by experimentally using a lexicon to look at each word in a sentence first as a verb and then as a noun. In Latin, there is generally ambiguity at the word level (at least between verb and noun). In Semitic languages and especially in the Arabic language, diacritics are used for precisely this task. Differences between verb, noun and other parts of speech are therefore recognizable at the syntactic level. This is the basic idea of the following Method, which is specially invented for the Arabic language. Its general definition also allows other languages that, similar to the Arabic language, contain syntactic structures that reflect semantic characteristics.

Method 8:

Input: Natural language sentence S, Diacritics-Grammar G, noun category sentence assignment list z, lexicon L

Output: Categorical sentence S′

Steps:
1. Result structure={ }
2. For all words w S:
   i. Search w in L
   ii. If w found:
      Add verb/noun/determined/indefinite tags to the
      Result structure on, else
         cancellation
3. Use G to find a correct derivative of S.
4. If derivation found:
   a) Search result structure in z
   b) If the result structure is found:
      Set S′=categorical sentence, else
         cancellation
5. Return S.

The following example explains how to perform this procedure for the Arabic language:

Given the sentence S=“ [symbol] ”

(English: “The boy's opinion is the best opinion.”)

Let G be the Diacritics-Grammar from Definition 7.

After Step 2 (always read from right to left)
ResultStructure=“noun/ [symbol] indefinite noun/ [symbol] indefinite
   Noun/ [symbol] determines noun/ [symbol] indefinitely”.

The derivation in FIG. 4A is then a correct derivation of S from G. FIG. 4B, however, shows a failed derivation if the diacritics are not taken into account.

Assignment list z contains the following data records (read from right to left):

| Noun sentence | Category-Sentence |
|---|---|
| Noun S₁ (determined), noun (indefinite) S₂ | (S₂ is S₁) |
| Noun S₁ (undetermined), noun | (S₃ + S₂ is S₁) |
| (determined) S₂, noun (indefinite) S₃ | |
| Noun S₁ (undetermined), noun | (S₄ + S₃ is S₂ + S₁) |
| (undetermined) S₂, noun | |
| (determined) S₃, noun (indefinite) S₄ | |

Method 8 outputs S′=[(S₄+S₃ is S₂+S₁)] as a category set for the above example.

6. IDC This invention assumes that the ontology relevant to the application is closed. The consequence of this is that complete induction can easily be applied to parts of this ontology, since the combinatorics always remain constant. The aim is to enable the user to discover unknown constraints and thereby increase the coherence of the logic of the overall system. The following basic Method for this component is defined in such a way that it can also be used for database records.

Method 9:

Input: set M of the selected decision terms, V set of the values of these terms, set S of the selected conclusion terms, V′ set of their values

Output: set M′ of the categorical constraints

Steps:
1. Establish a combinatorics table T for M and its values V
2. For all alle s∈S, v₁,v₂, . . . vₙ, Vᵢ∈V′ is the value of s:
   a) For each combinatorics theorem in T
   Set a suitable vᵢ (automatically, i.e., via recursive function, or manually)
3. For all subsets T′ of M with respective values t₁, . . .t, ∈V:
   a) Verify whether there is an s∈S, vᵢ is the value of s, such that:
   Each repeated appearance of the values t₁, . . . , tₙ in T in the column s contains the value vᵢ
   b) If yes: set new constraint=(t₁& . . . &tₙ>vᵢ)
4. Return all the constraints found

The following example illustrates the use of the above method in the context of the printing application.

Let M={printing group, type, numbering unit}, V={{1-color, multi-color}, {Heidelberg, Roland}, {available, not available}}. T (steps 1. and 2.) looks like this:

| | | | Conclusion |
|---|---|---|---|
| Printing group | Type | Numbering unit | s = Parts on discount |
| 1-color | Heidelberg | available | 1 |
| 1-color | Heidelberg | unavailable | 0 |
| 1-color | Roland | available | 0 |
| 1-color | Roland | unavailable | 0 |
| multicolor | Heidelberg | available | 1 |
| multicolor | Heidelberg | unavailable | 1 |
| multicolor | Roland | available | 1 |
| multicolor | Roland | unavailable | 1 |

The following subsets of M are formed in step 3:

(printing group)

(Type)

(Numbering unit)

(printing group, type)

(printing group, numbering unit)

(Type, numbering unit)

(printing group, type, numbering unit)

For (printing group) one finds the constraints: ((multicolor)>1)

There are no constraints for (type)

There are no constraints for (numbering unit)

For (printing group, type) one finds the constraints: ((1-color & Roland)>0), ((multicolor & Heidelberg)>1), ((multicolor & Roland)>1)

For (print group, numbering unit) one will find the constraints: ((1-color & not available)>0), ((multicolor & not available)>1), ((multicolor & available)>1)

For (type, numbering unit) one can find the constraints: ((Heidelberg & available)>1)

There are no constraints for (print group, type, numbering unit)

The constraints found reflect the following rules of the printing press industry:
1) One gets a discount on spare parts from multicolored Heidelberg and/or Roland printing machines
2) One does not get a discount for spare parts from Roland 1-color printing machines
3) If no numbering unit was delivered with a 1-color printing machine, whether Roland or Heidelberg, then there is no discount for spare parts of this machine.
4) One gets a discount for multi-colored machines, regardless of whether numbering units were delivered or not
5) Spare parts for a Heidelberg machine whose numbering unit has been delivered are always subject to a discount

7. RRC The Rational Response Component has the task of answering queries through logic-supported reactions. This is done on the assumption that there is a list of all categorical constraints, which is either explicitly defined in ODC or derived by Method 9 in the IDC.

Method 10:

Input: SQL query Qry, list of categorical constraints catCons

Output: Set M of all categorical constraints that belong to the query

Steps:
1. Execute Qry. Name the resulting table ReT.
2. Form the set M′ of all decision terms that occur in ReT
3. For each term b of M′:
   a) Search b in catCons
      If found: add constraint to the list of results
4. Return the list of results

As an alternative to SQL queries, categorical records can be searched directly in the RS. Since Method 6 in the DDC guarantees, by means of completeness and unity of the ontology, that every derivable sentence also exists in the extension of the ontology, a simple search procedure is sufficient for this type of query method.

Method 11:

Input: Categorical sentence s, list of all categorical sentences S, list of all categorical constraints const

Output: List of all categorical sentences/constraints that were involved in the derivation of s

Steps:
1. Search s in S
2. Search s in const
3. If found: return S∪const, else
   cancellation

### DESCRIPTION OF THE DRAWINGS

The present invention may be better understood, and its numerous features and advantages made apparent to those skilled in the art by referencing the accompanying drawings.

FIG. 1 illustrates the various components of the overall system with ODC, DTC, CDC, IDC, DDC, LRC, TRC, and RRC;

FIG. 2 executes an example of Method 1 on the CNF clause set:
S={{0,1} {0,2} {1,3} {2,3} {3,4}} where Method 1 sets up the BDD for S, but cannot convey any information about the number of possible solutions;

FIG. 3 executes Method 5 on the BDD created for the clause set
S={{0,1} {0,2} {0,4}} by means of Method 1;

FIG. 4A shows a correct derivation of S from G according to Method 8 with input of a natural language sentence S, Diacritics-Grammar G, noun category sentence assignment list z, and lexicon L;

FIG. 4B provides a failed derivation if a Diacritics-Grammar is not taken into account;

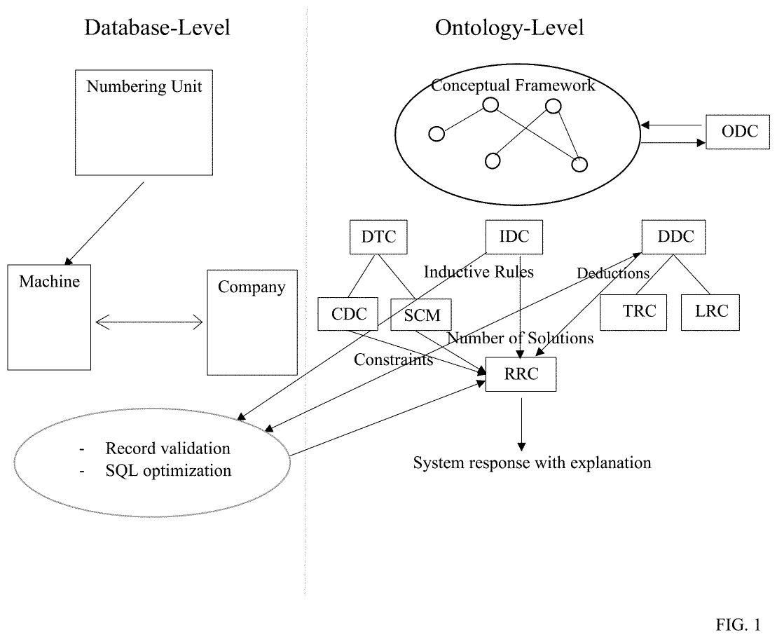

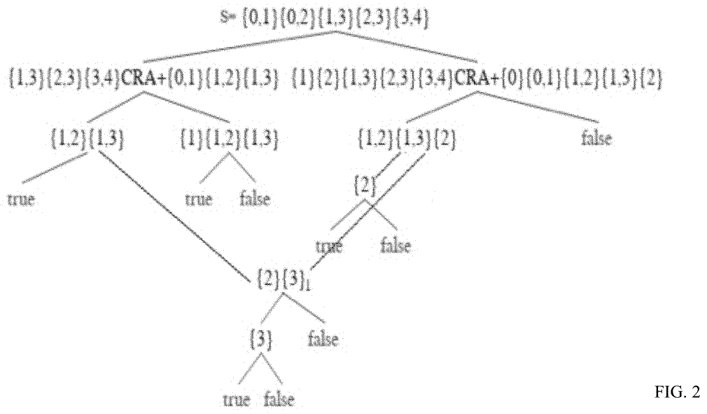

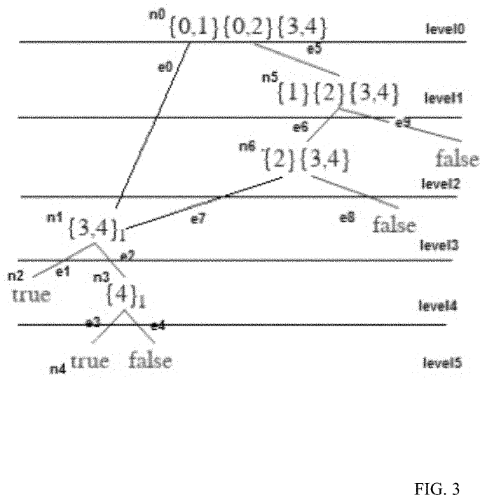

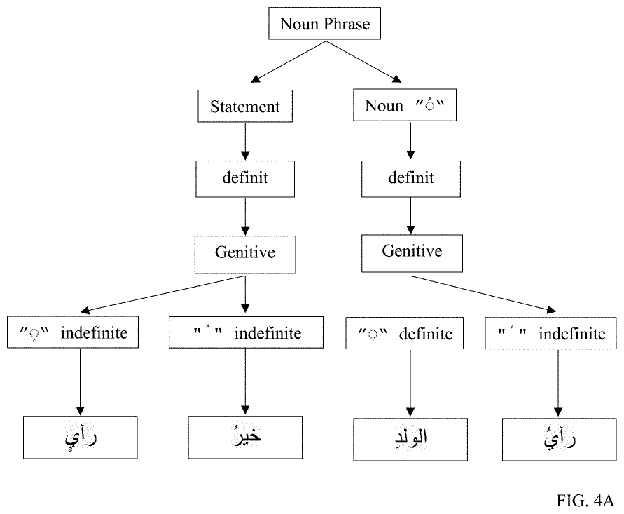

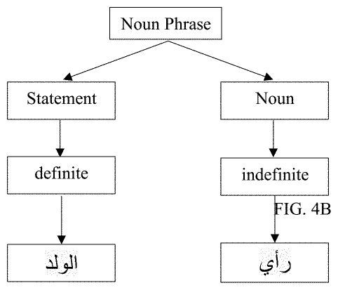

1. A method for creating an efficient, logically complete, ontological level in the extended relational database concept, characterized in that the catalog level is extended to a logically complete and closed ontology, called a Rational System (RS).

2. Method according to claim 1, characterized in that RS includes, inter alia, the following components:
a) Ontology Description Component (ODC), consisting of a graph- or logic-based editor of axioms (ontology structure) and facts.
b) Inductive Derivative Component (IDC), whose task is to generate combinatorics for selected parts of the overall system, for which no explicit constraints are known. In consequence, a complete induction procedure assists in inferring such constraints.
c) Deductive Derivative Component (DDC) that applies syllogisms to selected parts of the overall system using a Language Recognition Component (LRC). A Translation Component (TRC) ensures that records from the database are rewritten into categorical statements.
d) Rational Response Component (RRC), which can explain each response to a request made to the overall system by means of stored constraints.

3. Method according to claim 2, characterized in that categorical constraints are derived by means of complete induction (Method 9) in the IDC via selected parts of the overall system.

4. Method according to claim 2, characterized in that syllogisms and hypothetical syllogisms in the DDC are applied to selected categorical data sets of the entire system until no new sentences can be derived (Method 6). In addition, DDC contains a Translation Component (TRC) whose task is to convert selected data sets into categorical statements (Method 7). The language Recognition Component (LRC) of the DDC, however, has the task of converting sentences in natural language into categorical sentences.

5. Method according to claim 2, characterized in that inquiries are answered by logic-assisted reactions. This is done by means of Method 10, which abstracts concepts and the associated categorical sentences/constraints from SQL-queries. Alternatively, a categorical sentence can be searched directly and the associated terms/constraints found (Method 11).

6. Method according to which a Decision Tree Component (DTC) explicitly makes available selected CNF-form constraints by means of SAT-solver methods (Methods 1, 2, 3) as Binary Decision Diagrams (BDDs).

7. Method according to claim 6, characterized in that possible solutions of the CNF-formula are counted by means of Methods 4 and 5.

8. Method according to claim 6, characterized in that the concept of a logical variable x is based on the truth pattern of x obtained from the truth table.

9. Method according to claim 6, characterized in that a combinatorial space is generated with the resolution, which does not depend on the classical variable value combinatorics, but on the sequence and interaction of the truth pattern of the variables in the to be processed formula.

10. Method according to claim 6, characterized in that by means of the combinatorial space, a canonical division of the clause set in smaller clause sets is carried out, whose entire final value depends on their respective truth values alone.

11. Method according to claim 6, characterized in that the clause classification criteria of Method 2 (1-4) are met by applying as well as both, the resolution methods described in Methods 1 to 3 and the resulting CNF-formulas.

12. Method according to claim 6, characterized in that the combinatorial space by use of this canonical partition is converted to an efficient decision tree (BDD), which is equivalent to the classical truth table, although it does not include all the truth table combinatorics.

13. Method of using a Dia-Grammar for automatic recognition of natural language sentences. The Dia-Grammar allows control of the sentence and/or word derivation method by the umlauts and/or meta-symbols known from the natural language syntax (Method 8).
